(19) United States
(12) Patent Application Publication
(10) Pub. No.: US 2015/0246458 A1
(43) Pub. Date: Sep. 3, 2015

(54) DEVICE AND METHOD FOR CONTINUOUSLY PRODUCING PORTIONS

(71) Applicant: GEA FOOD SOLUTIONS GERMANY GMBH, Kempten (DE)

(72) Inventors: Thomas Gahler, Goerisried (DE); Ralf-Peter Müller, Kempten (DE); Alexander May, Waltenhofen (DE); Markus Moest, Boerwang (DE)

(21) Appl. No.: 14/431,564

(22) PCT Filed: Sep. 30, 2013
(86) PCT No.: PCT/EP2013/070337

§ 371 Date: Mar. 26, 2015

(30) Foreign Application Priority Data
Sep. 28, 2012 (DE) 10 2012 109 247.8

(51) Int. Cl. B26D 7/06; B26D 5/20

(52) U.S. Cl. CPC B26D 7/0625; B26D 5/20

(57) ABSTRACT

The invention relates to a device (5) for slicing several food products (2), in particular sausage, ham, and/or cheese, wherein a respective track (7) is provided for each food product (2), along which track the food product is transported in the direction of a moving blade (11). The invention further relates to a method for slicing at least two food products in two separate tracks (7). Each food product is transported along a track in the direction of a cutting blade (11) by a transport means (4). The cutting blade cuts food slices from the food product (2).

The present invention relates to a device for slicing several food products, in particular sausage, ham, and/or cheese, wherein a respective track is provided for each food product, along which track it is transported in the direction of a moving blade. The present invention further relates to a method for slicing at least two food products in two separate tracks, wherein each food product is transported along a track by a conveying means in the direction of a cutting blade, which cuts food slices from the food product.

Devices and methods of this type are well known from the prior art. However, the devices and methods in accordance with the state of the art have the disadvantage is that it is not possible to provide food slices continuously. Therefore expensive buffer storage or similar arrangements must be made available in a slicing line.

The devices known from the prior art have the further disadvantage that either a complicated construction with several cutting blades is provided or the tracks are displaceable laterally, thus essentially parallel to the principal plane of the cutting blade, in order to bring the food products alternately into a slicing position. Such devices have a complicated structure, are prone to requiring maintenance, and always have an idling period for a cutting blade during changeovers. In addition, it is thus not possible to slice several food, products at the same time with one cutting blade.

Therefore, it was the objective of the present invention to make available a method which does not have the disadvantages of the prior art.

The object is achieved with a device for slicing a plurality of food products, in particular sausage, ham and/or cheese, wherein a respective track is provided for each food product, along which it is transported in the direction of a moving blade, wherein each track can be adjusted from a charging position to a slicing position independent of the at least one other track.

The statements made on the subject of the present invention are equally applicable to the other subjects of the present invention and vice versa.

The present invention relates to a device for slicing food products, for example sausage, ham and/or cheese. Such slicing devices are also known by the person skilled in the art as ‘sheers’ or ‘high throughput sheers’. Such slicing devices have a moving, in particular rotating blade that cuts food slices from the front end of a food product. In doing so, the blade usually cooperates with a cutting edge that is provided, for example, at the front end of a product support and, with the cutting blade, defines the cutting plane in which the food slices are cut from the food product. A blade clearance is formed between the blade and the cutter bar which should be as small as possible, to prevent parts of the food product being ‘chopped off’. However, the blade clearance must be sufficiently large so that, as far as possible, the blade does not come into contact with the cutting edge. During slicing, the food product is transported continuously or intermittently in the direction of the cutting blade. The separated food slices fall, for example, onto a delivery table, on which they are combined into portions. As soon as a portion is complete, it is removed from the discharge area of the blade and the slicing of a new portion can begin. According to the invention, the slicing device has multiple tracks, i.e. several food products can be sliced by one blade, in particular at least partly simultaneously or at least partly sequentially. For this purpose, the device has a specific track for each food product, along which it is transported in the direction of the blade. The invention now further provides that each track is provided to be adjustable, independent of the at least one other track, from a loading position to a slicing position. In the loading position, in which the track is preferably at least partially lowered, it is loaded with a new food product to be sliced. In the slicing position, in which the track is preferably inclined in relation to the horizontal so that the track slopes in the direction of the blade, the food product is sliced. Because each track can individually switch between the positions, it is possible to load a track with a new food product while the food product in the other track is still being sliced, so that there is a continuous product flow of cut-off food slices, so that the buffer capacity to be provided in the line is at least reduced and/or it is not necessary to reduce the output of the following packing machine

Preferably, the angle of inclination of the respective track can be adjusted.

Preferably, each track has a conveying means, for example a belt conveyor or an endless belt that can be driven independent of the conveying means of the other tracks. Thus the thickness of the slices that are cut in each track can be independently chosen. In addition, the loading of a track with a new food product takes place independent of the other track.

Further, each track preferably has a gripper, with which the end of the food product remote from the cutting blade can be gripped in the respective track. This gripping takes place preferably against the end of the cut of the respective food product, in order to stabilise the end of the food product during slicing and/or to dispose of the remaining piece that cannot be sliced. This gripper is preferably operated and/or driven independent of the other grippers.

Preferably, a gripper is provided in each track, with which the rear end of the food product is gripped. The food product can be transported with this gripper in the direction of the cutting blade. In particular, the gripper is however used to stabilise the food product, when its cut is already well advanced, and/or to transport an unsliced end piece away from the blade.

Preferably, the tracks have a common axis of rotation, so that they can be rotated from the feed position to these slicing position and vice versa, wherein it is particularly preferred for each track to have its own drive and/or a gear unit, so that the two tracks can be transferred into the respective position independent of one another.

In a preferred embodiment, the device has a delivery table, on which the cut off food slices are configured to portions. Particularly preferably, the delivery table can be moved horizontally transverse to the direction of transport of the food products, so that food slices that are sliced in different tracks can be laid in the same position on the delivery table.

Preferably, the tracks are provided fixedly* thus in particular non-displaceably, transverse to the direction of the cutting blade. Advantageously, continuous operation is thereby possible, since a food product on a track can be sliced in these slicing position while a further track is adjustable into a loading position without the necessity of an idling period for the cutting blade during the adjustment period.

Particularly preferably, the tracks are only adjustable in the angle of inclination, thus in particular are fixed in directions parallel and/or perpendicular to the cutting blade. The person skilled in the art understands that this does not apply in particular to conveying means and/or grippers, in order to ensure a supply of food product.

Preferably, the device just has one cutting blade.

The person skilled in the art understands that, if the tracks are fixed but are adjustable in the angle of inclination, it is preferable to provide a cutting blade of a size that is sufficient to slice food products on each track without a change of position.

Alternatively or additionally, a track correction belt is provided downstream of the slicing device, with which portions can be shifted from one track to another track.

Preferably, the slicing device in accordance with the invention has a sensor, which determines the portion of each food product that has not yet been sliced. With the aid of the signal from this sensor, a control system preferably controls the feed rate and/or the reloading of each track so that portions are sliced continuously.

A further subject of the present invention is a method for slicing at least two products in two separate tracks, wherein each food product is transported along a track by a transport means in the direction of a cutting blade which cuts the food slices from the food product, in which the feed speed and/or the reloading time of the respective track is so chosen that food slices are cut from at least one food product continuously.

The statements made on this subject of the present invention are equally applicable to the other subjects of the present invention and vice versa.

Preferably, the slicing device has two, three, four or more product lines, each of which can be loaded with a food product, which is transported along the line in the direction of the cutting blade. The food products can be sliced at least intermittently simultaneously or sequentially. The feed rate in each track can be individually adjusted, so that the thickness of the slices which are cut off the respective food product can be different. If the slicing device has three product lines, for example, two food products can be sliced, for example, while the third line is reloaded. In the period in which a new food product is then put in this line, the other two lines are reloaded etc. With four or more lines, a similar procedure can be conceived wherein, with four or more lines, two can each be loaded and two can be sliced. Preferably, each line has a gripper with which the end of the food product remote from the blade can be gripped. These grippers can preferably be independently operated and/or driven.

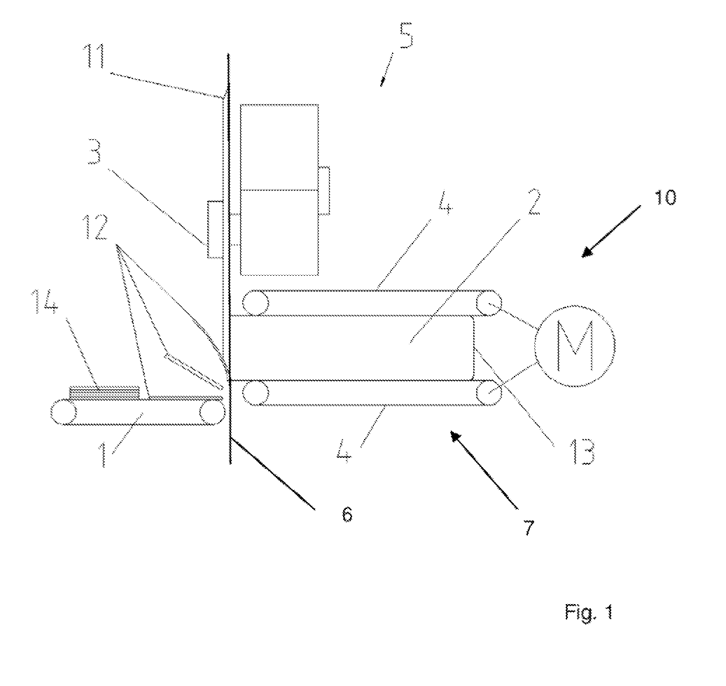

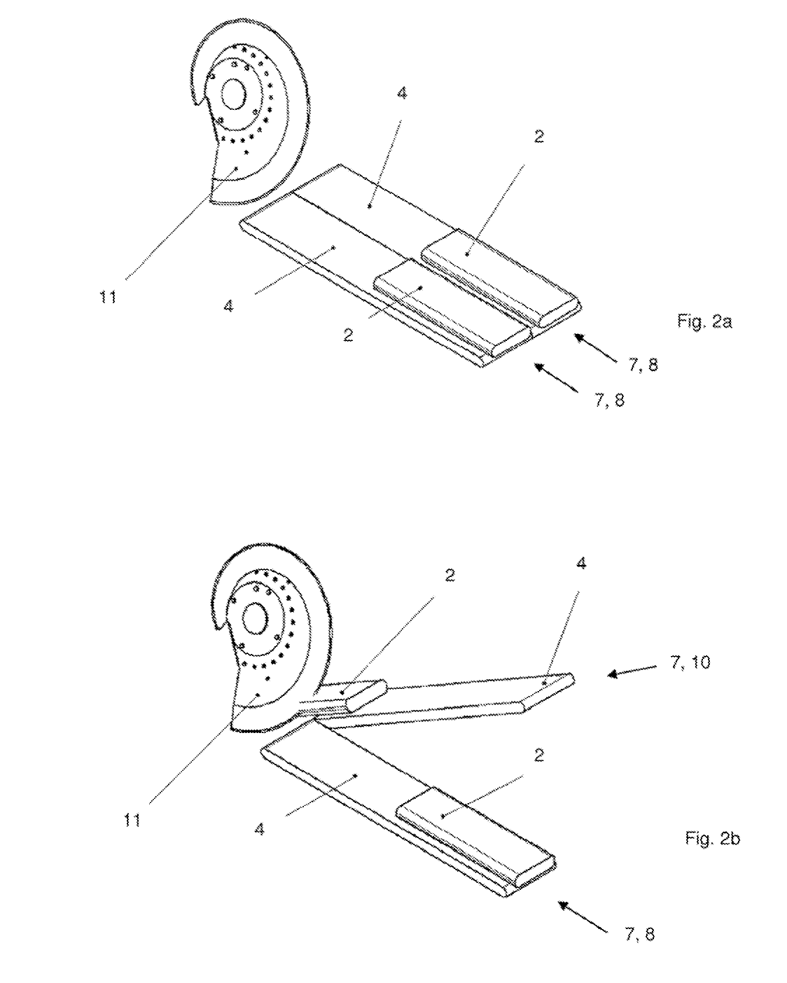

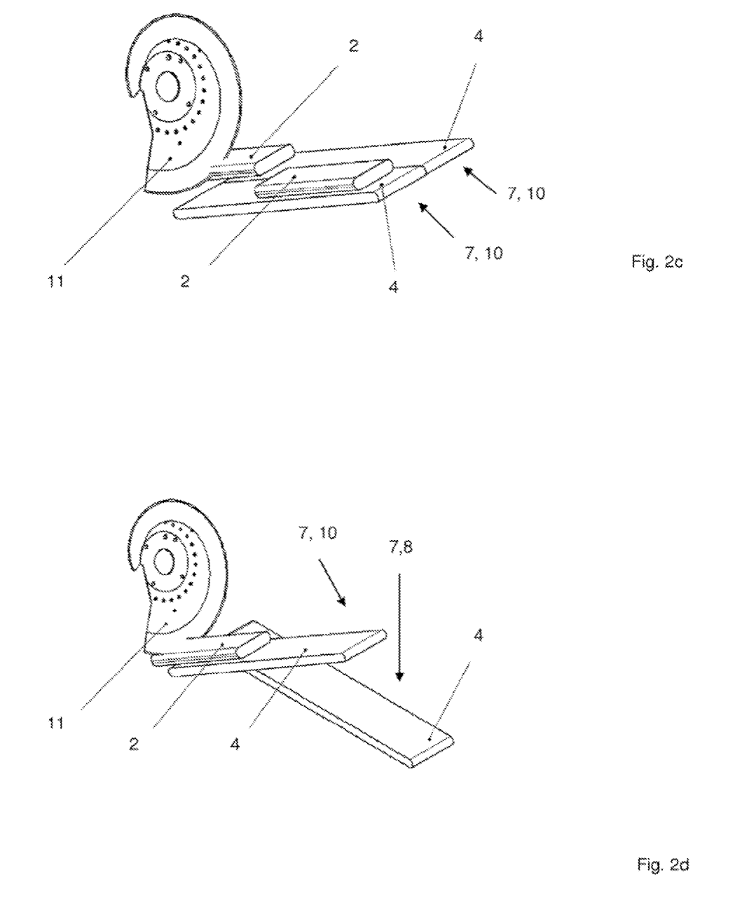

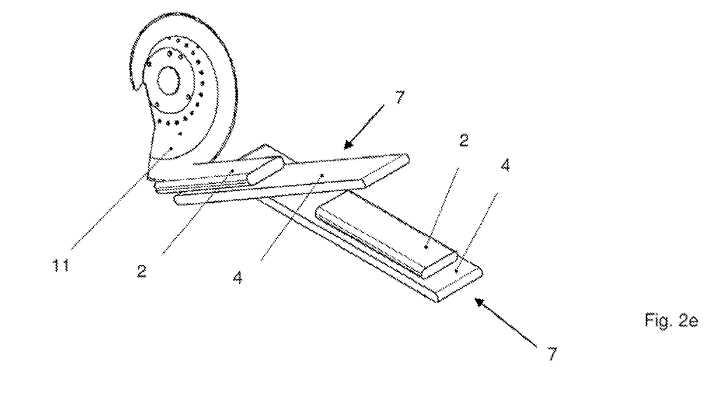

In the following, the invention is explained with the aid of FIGS. 1 and 2. These explanations are solely by way of example and do not limit the general inventive concepts. The explanations are equally applicable to all subjects of the present invention.

FIG. 1 shows a slicing device 5. The slicing device 5 has a blade 11, which cuts a food product 2 into food slices 12. For this purpose, each food product 2 is transported by a conveying means 4, here two conveyor belts 4, continuously or intermittently in the direction of the cutting plane 6 of the blade 11. The lower conveyor belt 4 at the same time forms a product support. The cutting blade 11 is fastened on a rotating blade mount 3 and cooperates during cutting with a cutting edge 9 (see FIG. 2) which, for example, is provided on the front end of a product support 4 to jointly define the cutting plane 6. A so-called blade clearance exists between the blade 11 and the cutting edge 9 which should be as small as possible, but must be large enough to prevent the blade contacting the cutting edge, however. This clearance must be regularly adjusted. This can be done by movement of the blade and/or the cutting edge. In addition, the cutting edge must be aligned parallel to the blade. Alter slicing, the food slices normally fall onto a delivery table 1, which is provided with transport means on which they are each configured to a portion 14, here a stack. The completed portions 14 are then transported away from the blade area and are packed. The thickness of the slice depends on the distance over which the food product is fed between two cuts. With a constant speed of rotation of the blade, the thickness of slices is controlled by means of the feed rate of the food product. The slicing device can have one gripper (not shown) per feed line which grips the rear end 13 of the food product 2 before or during slicing and steadies this during slicing.

According to the invention, the slicing device is provided with multiple tracks, i.e. a plurality of food products 2 are sliced by a blade, in particular at least intermittently at the same time or at least intermittently sequentially. For this purpose, the device has a separate track 7 for each food product, along which it is transported in the direction of the blade 11. Furthermore, it is now provided according to the invention that each track 7 can be adjusted independent of the at least one other track from a charging position 8 into a slicing position 10. In the charging position 8, in which the track is preferably lowered, at least in part, it is loaded with a new food product 2 to be sliced. In the slicing position 10, in which the track is preferably inclined in relation to the horizontal so that the track slopes in the direction of the blade, the food product is sliced. Because each track 7 can individually switch between the positions, it is possible to load a track with a new food product while the food product in the other track is still being sliced, so that there is a continuous product flow of cut-off food slices, so that the buffer capacity to be provided in the line is at least reduced and/or it is not necessary to reduce the output of the following packing machine. Here the tracks 7 are immovably arranged in a direction essentially parallel to the cutting blade, i.e. they are fixed.

FIG. 2 shows details of the slicing device according to the invention. It can be clearly seen that the slicing device according to the invention is implemented in the present case with two lanes, i.e. has two tracks 7, each of which is provided with its own transport means 4, with which a food product 2 can be respectively moved in the direction of the blade independent of the other track. Furthermore, it can be seen from Figure 2 that each track is so implemented that be can be transferred independent of the other track from a loading position 8 to a charging position 10, in the present case by rotating or pivoting the respective track.

FIG. 2a shows both tracks in the loading position 8. One track is then raised into the loading position and the food product is transported by the transport means in the direction of the cutting blade and there is sliced (see FIG. 2b). As soon as the slicing of this food bar has reached a certain stage of progress, the other track ease is likewise brought into the slicing position 10 and the product 2 is transported in the direction of the blade, but not yet sliced, as shown in FIG. 2c. Slicing only starts when the other product has been at least mostly sliced. As soon as slicing of this product is finished, the other product is sliced and the other track is again brought into the loading position 8 (see FIG. 2d) and provided with a new product (see FIG. 2e). Thus it is possible to produce a continuous flow of sliced food slices.

### LIST OF REFERENCE SYMBOLS

1 Delivery table
2 Food product
3 Blade mounting
4 Support surface, transport means of a track 7
5 Slicing device
6 Cutting plane
7 Track
8 Feed position
9 Cutting edge
10 Slicing position
11 Blade, circular blade
12 Food slices
13 Rear of the food product
14 Portion, food portion

What is claimed is:

1. A device for slicing a plurality of food products comprising: a respective track for each food product, along which track the plurality of food products are transported in a direction of a moving blade,
wherein each of the respective tracks are provided to be adjustable into a slicing position from a loading position independent of at least one other track.

2. The device in accordance with claim 1, wherein the respective track is adjustable in its angle of inclination.

3. The device in accordance with claim 1, wherein each track has a conveying means that can be driven independent of the conveying means of the other tracks.

4. The device in accordance with claim 1, wherein each of the tracks have a common axis of rotation.

5. The device in accordance with claim 1, wherein the device has a delivery table, on which the cut off food slices are configured to portions.

6. The device in accordance with claim 1, wherein a track correction belt is provided downstream.

7. The device in accordance with claim 1, wherein the device has a sensor, which detects the proportion of each food product not yet sliced.

8. The device in accordance with claim 7, wherein a control system controls the loading and/or reloading of each track so that portions are sliced continuously.

9. A method for slicing at least two food products in two separate tracks comprising:
transporting each food product along a track by a transport means in a direction of a cutting blade which cuts the food slices from the food product,
wherein a feed speed and/or a reloading time of the respective track is chosen so that food slices are cut continuously from at least one food product.

10. The device in accordance with claim 1, wherein the plurality of food products are sausage, ham, and/or cheese.

11. The device in accordance with claim 2, wherein each track has a conveying means that can be driven independent of the conveying means of the other tracks.

12. The device in accordance with claim 3, wherein each track has a conveying means that can be driven independent of the conveying means of the other tracks.

13. The device in accordance with claim 2, wherein each of the tracks have a common axis of rotation.

14. The device in accordance with claim 12, wherein each of the tracks have a common axis of rotation.

15. The device in accordance with claim 2, wherein the device has a delivery table, on which the cut off food slices are configured to portions.

16. The device in accordance with claim 14, wherein the device has a delivery table, on which the cut off food slices are configured to portions.

17. The device in accordance with claim 2, wherein a track correction belt is provided downstream.

18. The device in accordance with claim 16, wherein a track correction belt is provided downstream.

19. The device in accordance with claim 18, wherein the device has a sensor, which detects the proportion of each food product not yet sliced.

20. The device in accordance with claim 19, wherein a control system controls the loading and/or reloading of each track so that portions are sliced continuously.
